(19) United States
(12) Patent Application Publication
(10) Pub. No.: US 2007/0055513 A1
(43) Pub. Date: Mar. 8, 2007

(54) Method, medium, and system masking audio signals using voice formant information

(75) Inventors: Kwang-il Hwang, Suwon-si (KR); Sang-ryong Kim, Yongin-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/489,549

(22) Filed: Jul. 20, 2006

(30) Foreign Application Priority Data
Aug. 24, 2005 (KR) 10-2005-0077909

(51) Int. Cl. G10L 15/20

(52) U.S. Cl. 704/233

(57) ABSTRACT

A method, medium, and system for masking voice information of a communication device. The method of masking a user's voice through an output of a masking signal similar to a formant of voice data may include dividing the voice data received into frames of a predetermined size, transforming the frames on a frequency axis thereof, regarded as a domain, obtaining formant information of intensive signal regions in the transformed frames, generating a sound signal disturbing the formant information with reference to the formant information, and outputting the sound signal in accordance with a time point when the voice signal is output.

### CROSS-REFERENCE TO RELATED APPLICATIONS

This application is based on and claims priority benefit from Korean Patent Application No. 10-2005-0077909, filed on Aug. 24, 2005, the disclosure of which is incorporated herein in its entirety by reference.

### BACKGROUND OF THE INVENTION

1. Field of the Invention

Embodiments of the present invention relate at least to a method, medium, and system for disturbing an audio signal, and more particularly to a method, medium, and system for masking a voice signal through an output of a disturbance signal based on formant information of the voice signal.

2. Description of the Related Art

Mobile phones, wired telephones in offices, and others, have often failed to maintain privacy between the participants of the underlying conversations. In particular, in order to prevent such conversations from being overheard or picked up by surveillance devices, a speaker usually has to either avoid such conversations in public or move to a more private location. Accordingly, there has been a desire for a way to maintain the privacy of a phone conversation without requiring the avoidance of public conversations or movement to such a private location. One problem has also been that when a user makes or receives a phone call in a public space when the conversation cannot be avoided or where the user cannot move to another location, e.g., to a car or a meeting room of an office, the conversation may be overheard by others or even picked up by devices.

Korean Patent Unexamined Publication No. 2005-21554 discusses dividing a voice signal into segments of a specified length, and then transmitting the segments with their orders changed. By transmitting the segments in the changed order, it is difficult for others to discover the content of the conversation.

This technique refers merely to the transfer of the original voice signal with noise already added thereto. Nevertheless, since human hearing has a capability to discriminate between the added noise and voice signal, i.e., typically the voice signal can be distinguished from the noise produced through the segmentation of the voice signal. Accordingly, in such a technique that generates loud noise to prevent those surrounding the reproduction of the conversation from perceiving/understanding the content of the conversation, without hindering the call, it becomes difficult for a user to discriminate the content of the conversation from the added noise, and has also become not effective since surveillance devices can also discriminate between the added noise and the voice.

In addition, Korean Patent Unexamined Publication No. 2003-22716 discusses attaching a voice mask to a speaker of a phone. However, according this technique, the user can hardly hear the voice due to the voice mask, and the user must put his/her face very close to the speaker, which also decreases its usability. In addition, regardless of how close the user puts his/her face to the speaker, the mask cannot prevent some of the conversation from being overheard, and therefore permitting surveillance devices to capture the content of the conversation.

Accordingly, the present inventors have found a need for a way to maintain the privacy of a conversation without requiring the user to move a less public area or to another location, and which prevents others from overhearing and/or devices from capturing the content of the conversation. In other words, there has been found a desire for a method, medium, and system that can prevent others from overhearing and/or devices from capturing the content of a conversation without hindering the underlying conversation.

### SUMMARY OF THE INVENTION

Accordingly, embodiments of the present invention have been made to solve at least the above-mentioned problems, with aspects being to maintain the privacy of a conversation by preventing the content of an audible reproduction, e.g., through a mobile-phone or a wired-telephone call, from being overheard by another person or device.

Another aspect of embodiments of the present invention is to allow a user to hear a voice during a conversation without hindrance, while preventing anyone around the conversation from overhearing the content.

Additional aspects and/or advantages of the invention will be set forth in part in the description which follows and, in part, will be apparent from the description, or may be learned by practice of the invention.

To achieve the above and/or other aspects and advantages, embodiments of the present invention include a method of masking voice information, including dividing voice information into a plurality of frames, obtaining formant information from intensive signal regions within each of the plurality of frames, generating a sound signal related to the formant information for each of the plurality of frames, and outputting the sound signal based on a time when the voice information is to be output.

The method may further include transforming each of the frames into a frequency domain and measuring magnitudes within each transformed frame.

In addition, the method may include receiving the voice information.

Further, the dividing of the voice information may include dividing frames such that the divided frames are continuous and overlap by a predetermined amount.

The dividing of the voice information may further include dividing frames as windows of a predetermined size, the windows being divided from the voice information to overlap by an amount smaller than the predetermined size of the windows.

The frames may result from dividing the voice information at predetermined time intervals. In addition, the obtaining of formant information for intensive signal regions may involve obtaining formant information according to frequency, bandwidth, and/or energy information of each respective frame.

The sound signal may be a signal offsetting frame energy of at least one formant of each frame. In addition, the generating of the sound signal may include generating and combining sound signals generated for multiple frames.

The sound signal may be output through an output unit that does not output the voice information.

To achieve the above and/or other aspects and advantages, embodiments of the present invention include a system for masking voice information, including a frame generation unit to divide the voice information into a plurality of frames, a formant calculation unit to calculate formant information from intensive signal regions within each of the plurality of frames, a disturbance-signal generation unit to generate a sound signal related to the formant information for each of the plurality of frames, and a disturbance-signal output to output the sound signal based on a time when the voice information is to be output.

The frame generation unit may further transform each of the frames into a frequency domain and measures magnitudes within each transformed frame.

The system may further include a receiving unit to receive the voice information.

The dividing of the voice information may include dividing frames such that the divided frames are continuous and overlap by a predetermined amount.

In addition, the dividing of the voice information may include dividing frames as windows of a predetermined size, the windows being divided from voice information to overlap by an amount smaller than the predetermined size.

The frames may result from dividing the voice information at predetermined time intervals.

The formant calculation unit may further obtain the formant information according to frequency, bandwidth, and/or energy information of each respective frame.

The sound signal may be a signal offsetting frame energy of at least one formant of each frame. The disturbance-signal generation unit may further generate and combine sound signals generated for multiple frames.

The system may further include a disturbance selection unit to selectively control masking of the voice information.

In addition, the system may include a communication device to transmit and receive audio information.

Further, the system may include a first speaker to output the voice information and a separate second speaker to output the sound signal. Here, the frame generation unit, the formant calculation unit, the disturbance-signal generation unit, the disturbance-signal output, and the first and second speakers may be embodied in a single apparatus body.

To achieve the above and/or other aspects and advantages, embodiments of the present invention include at least one medium including computer readable code to implement embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a sound system with a receiver-side portion, according to an embodiment of the present invention;

FIG. 2 illustrates a spectrogram of a voice signal by frame, in a frame generation unit, according to an embodiment of the present invention;

FIG. 3 illustrates a spectrogram of a disturbance signal based on a formant analysis, according to an embodiment of the present invention;

FIG. 4 illustrates spectrograms of a voice signal that a receiver hears and a sound signal of the surroundings, the sound signal being generated by adding a disturbance signal to the voice signal, according to an embodiment of the present invention;

FIG. 5 illustrates a process of outputting a disturbance sound signal based on obtained formant information of voice data, according to an embodiment of the present invention;

FIG. 6 illustrates an example of a processing of a voice signal, according to an embodiment of the present invention; and

FIG. 7 illustrates a mobile phone, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

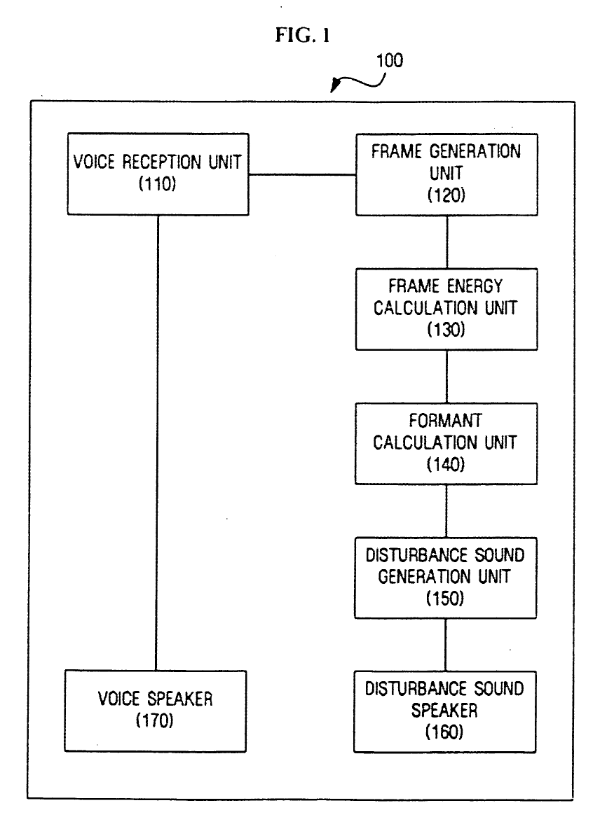

FIG. 1 illustrates a sound system with a receiver-side portion, e.g., through a receiver sound processor, according to an embodiment of the present invention. In this example embodiment, the receiver-side sound processor 100 may include a voice speaker 170 for outputting a received sound, e.g., a voice portion of a conversation, and a voice reception unit 110 for converting an analog signal, e.g., from the voice speaker 170, into a digital signal and storing the digital signal, or directly receiving a digital signal being output to the voice speaker 170, so as to process a voice signal, for example. The processor may further include a frame generation unit 120 for analyzing and processing frames of the voice signal being output to the voice speaker 170, a frame-energy calculation unit 130, a frame-formant calculation unit 140, a real-time disturbance-sound generation unit 150, and a real-time disturbance sound speaker 160, for example.

Received voice sampling data may be divided into frames of a predetermined size, for example, 10 ms, 20 ms, 30 ms, or others, by the frame generation unit 120. In addition, the frames may be sampled such that specified portions overlap. This overlapping may prevent a disconnection of voice information during transitions between frames in the course of the signal processing, e.g., permitting the extraction of characteristics of one frame from previous data.

In the frame generation process, voice data may pass through a pre-emphasis filter to emphasize a high level portion thereof, and a Hamming, Hanning, Blackman, or Kaiser window may be adapted thereto, noting that in some embodiments of the present invention, the adaptation of the pre-emphasis filter or window may be omitted. After obtaining such frames, energy for the frame is then detected, e.g., generally in the unit of a dB. The formant calculation unit 140 may then find formants from a frame, e.g., three to five formants from a frame.

Formants are important features in each frame, from the viewpoint of psycholinguistics. Sound is actually made up of periodic vibrations that are propagated to an ear, e.g., a human hearing organ (eardrum, cochlear canal, nerve cell, and others), through a medium, such as air. In the case of a voice generated by a human vocal organ (lungs, vocal cords, oral cavity, tongue, and others), sounds of various frequencies overlap. By analyzing the energy distribution of the sounds making up the voice, according to frequencies, fundamental frequencies from vibrations of the vocal cords upon making voice may be detected. Here, as an example, three to five frequency regions may be generated by a resonance effect of the vocal cords and may be identified as having higher energy as compared with the surrounding audio information. The frequency region is called a formant. The formants are varied with time according to the content of speaker's voice, and a listener can recognize and understand the speaker's voice through the variation information of the formants. Accordingly, similar to a principle of the present invention, if formant information of the speaker is concealed from the listener, the listener will not be able to perceive or understand the speaker's voice. Formant information may include a frequency, bandwidth, energy or gain of a signal, and others, for example.

As an only an example, formant finding methods include an estimation method by linear predictive coding (LPC) analysis, and an estimation method by a voice feature vector of MFCC coefficients, LPC cepstrum coefficients, PLP cepstrum coefficients, filter bank coefficients, or others. The LPC analysis obtains the voice samples with a linear equation that is the weighted combination of the previous voice samples. Herein, the resonance frequencies of the complex poles of the linear equation indicate peaks in a spectral energy of a voice signal, which peaks are candidates of the formants. In addition, the radii of the complex poles are the candidates of the bandwidths and energies of the formants. Since there are several complex poles of the linear equation, i.e., the candidates of the formants, a dynamic programming algorithm can be used for an optimum selection thereof. Accordingly, the optimum combination is selected and adapted from the plurality of complex poles, and whether or not to adapt is determined through comparing a result of adaptation. Other than the dynamic programming algorithm, various optimizing algorithms based on a hidden Markov model (HMM) or an expectation maximization (EM) algorithm, and other search algorithms can equally be adapted.

The estimation method using a voice feature vector, such as MFCC coefficient, is a method which includes finding a feature vector from a voice signal, and extracting formant information using various study algorithms, such as HMM. An MFCC coefficient is found by passing the voice signal through an anti-aliasing filter, and converting the output into a digital signal x(n) through an analog/digital (A/D) conversion. The digital voice signal passes through a digital pre-emphasis filter with a high-bandwidth passing characteristic. This filter first serves to perform a high-bandwidth filtering for modeling a frequency characteristic of the external ear/middle ear of a human being. This filtering compensates for the reduction to 20 dB/decade by vocalization through lips, thereby obtaining only a vocal tract characteristic from voice. The filter second serves to compensate to some degree for the fact that a hearing organ is susceptible to a spectrum region of 1 kHz or more. Meanwhile, in PLP feature extraction, an equal-loudness curve, which is a frequency characteristic of a human hearing organ, is directly used in modeling. Generally, a characteristic H(z) of a pre-emphasis filter can be expressed by the following Equation 1.
H(z)=1−az⁻¹ Equation 1:

Here, a is may be in the range of 0.95-0.98.

A pre-emphasized signal is generally adapted with a hamming window, being divided into frames in block units. Post processes may all be implemented in frame units. Here, the size of a frame may be in general 20-30 ms, and potentially have a frame shift of 10 ms, according to an embodiment of the present invention. A voice signal of one frame may be transformed into a frequency region using fast Fourier transform (FFT). In addition to FFT, a transform method such as discrete Fourier transform (DFT) can also be used. Here, a frequency bandwidth is divided into a plurality of filter banks, and the energy of the respective filter banks is found. Final MFCC is obtained by taking logarithms of band energy and transforming it with discrete cosine transform (DCT). A method of setting a mean frequency and a shape of the filter bank can be determined in a Mel-scale distance in consideration of the hearing characteristic of the ear (i.e., the frequency characteristic of a cochlear canal), for example.

Cepstrum coefficients may be obtained by extracting a feature vector with LPC, FFT, or others, and adapting logarithmic scales to the same. By the adaptation of logarithmic scales, a profile of uniform distribution can be provided in which the coefficients with small difference have a relatively large value, and the coefficients with large difference have a relatively small value. The result of this is the cepstrum coefficient. Accordingly, the LPC cepstrum method results in the coefficients having a profile of uniform distribution through the cepstrum after using LPC coefficient in extracting the feature.

In another method of obtaining the PLP cepstrum, in the PLP analysis, a filtering may be implemented to a frequency region using a human hearing characteristic, and the filtered frequency region is transformed into the autocorrelation coefficient, and again into the cepstrum coefficient. A characteristic of hearing sense susceptible to time variation of a feature vector can also be used.

Finally, the filter bank may also be realized in a time region using a linear filter, but in general by a method in which a voice signal is FFT-transformed and the sum of the magnitude of the coefficient corresponding to the respective bands is calculated while adapting the weighted value thereto.

When three to five formants are obtained through calculation, a disturbance sound disturbing the talker's voice can be generated using the formants. Since the others that may overhear a conversation may perceive the contents of the conversation during a phone call, for example, similarly based on the formants as the desired listener, additional sounds, which are based on the formants, can be generated to confuse or disrupt the perceiving by those overhearing the conversation, i.e., the undesired surrounding listeners cannot recognize the contents of the conversation during the call since the formants used to understand the conversation are either unavailable or disrupted. The generated disturbance sounds 150 may also be output through the speaker 160. With the output of these other sounds corresponding to the formants, a voice signal can become masked or disturbed even when the loudness of the disturbance sounds is not essentially larger than that of the voice signal heard by the authorized listener, such that the authorized listener can perceive the voice signal without hindrance.

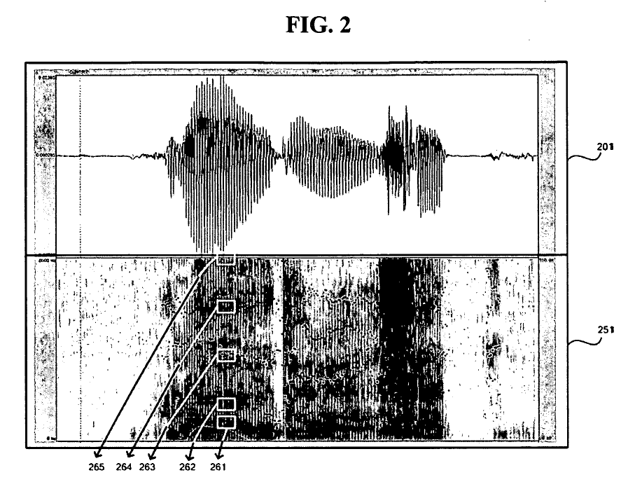

FIG. 2 illustrates a spectrogram of a voice signal, by frames, in a frame generation unit, according to an embodiment of the present invention.

When the voice signal 201 is input, the signal may be divided into pieces with of predetermined sizes. As illustrated in FIG. 2, the voice signal 201 may be divided into 20 ms slices, and adapted with a hamming window so that the slices overlap each other by 10 ms, for example. As a result, a plurality of frames can be obtained. Such frames are shown in the graph 251, where it can be seen that the densely distributed signals are depicted in a portion of the graph 251 that corresponds to a portion where the voice signal is provided in the graph 201. In the graph 251, the formants indicative of intensive signal regions can thus be obtained. Here, the formants are characteristic features of a voice like a fingerprint. In this embodiment, the formants 261, 262, 263, 264, and 265 result from the extraction of dark portions in the frames. In FIG. 2, the formants of the respective frames have also been depicted in a solid line connecting between points.

The frequency of a voice signal generally ranges from 300 Hz to 8000 Hz. In the range, three to five formants may be extracted, for example, wherein a first formant 261 provides the most information for understanding a voice. Subsequently, second, third, and other formants 262 and 263 are also provided.

The disturbance sound generation unit 150, as illustrated in the embodiment of FIG. 1, may generate a sound that corresponds to the respective formants extracted. This may be done by the modulation of a predetermined sound wave, or the introduction of a sound corresponding to each formant from a sound such as purl or birdcall. In the former case, making the sine waves have pink noise is an exemplary modulation. When the sounds corresponding to the respective formants have been generated, other sounds of similar formants may be generated, e.g., in a delayed interval by 10 ms from the actual voice signal, noting that alternative embodiments are equally available. In such an embodiment, the delay of 10 ms is due to the aforementioned overlapping of voice signal by 10 ms. Since the hearing sense of a human being may not be able to identify this difference, the surrounding listeners effectively hear the original voice signal and the disturbance sound at the same time. When the disturbance sound, having the similar formant to that of the voice, has been output, the surrounding undesired listeners simultaneously hear the disturbance sound, and any portion of the voice signal they can hear, cannot understand the meaning of the voice signal. In an embodiment of the present invention, since the loudness of the disturbance sound is proportional to that of the voice signal, embodiments of the same are different from that the aforementioned conventional techniques that output abnormally loud sounds, e.g., a steam whistle, to disturb undesired listeners from hearing or understanding a conversation during.

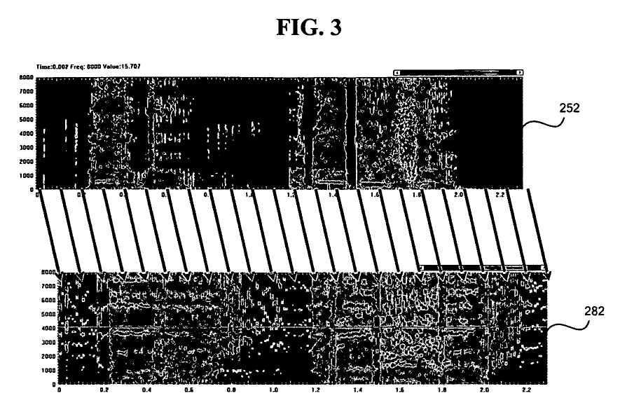

FIG. 3 illustrates a spectrogram of a disturbance signal based on a formant analysis result, according to an embodiment of the present invention. The spectrogram 252 shows a continuous profile of frames of the voice signal generated by a frame generation unit 120, such as that shown in FIG. 1. As seen in FIG. 2, formant information can also be obtained from this spectrogram. Formant information means portions where signals are intensively depicted in the respective frames. The voice can be identified by the formants so that the meaning of the voice, and the contents of the conversation, can be understood. Accordingly, when undesired surrounding listeners overhear the voice sound combined with the additional sound signal containing similar formant information, the surrounding listeners recognize the combination as a signal with a different formant, thereby hardly identifying the contents of the conversation.

When a predetermined sound is generated based on formant information of the spectrogram 252, the illustrated spectrogram 282 is obtained. The indication of inclined arrows between the spectrograms 252 and 282 is because there is a time interval between the frames in the spectrogram 252 and the frames of the spectrogram 282 generated based on the formants of the former frames. In dividing the frames, in hamming window manner, with the overlap by 10 ms, there is caused a time interval delayed by 10 ms from original voice signal. Of course, if it takes some time in generating a new sound, the time may also form a time interval.

However, since such time intervals are not large, the additional sound and the original voice signal are both heard by the surrounding listener almost at the same time. The sounds collected in the spectrogram 282 illustrated the disturbed formant information of the spectrogram 252 to mask the voice signal of spectrogram 252. Accordingly, because of the sounds disturbing the formants of a speaker's voice signal, the sounds heard by undesired surrounding listeners are different and differently understood than those heard and understood by receiver.

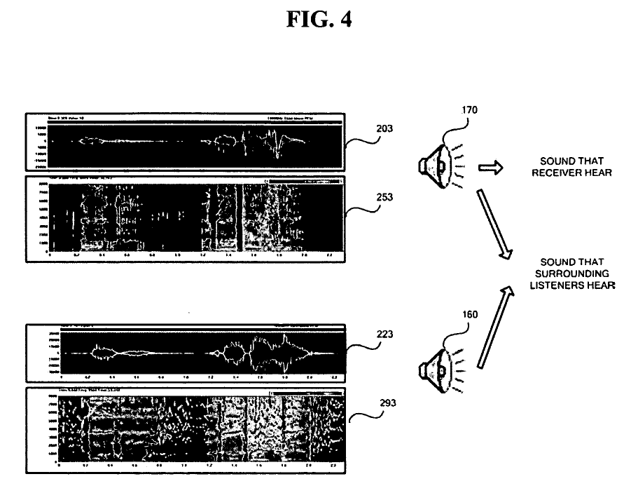

FIG. 4 illustrates spectrograms of a voice signal that a receiving listener hears and an additional sound signal that the undesired surrounding listeners hear, respectively, with the additional sound signal being generated to cause a disturbance signal bed added over the voice signal. The speaker's voice signal 203 is a signal that a receiving listener hears through the voice speaker 170. A reference numeral 223 denotes the additional sound signal of the spectrogram 293 in which a disturbance signal is generated based on formant information obtained from the disturbed spectrogram 253. This additional sound signal may be heard by the undesired surrounding listeners through the disturbance sound speaker 160 or an external speaker of a mobile phone, for example.

Since the disturbance sound is output through the external speaker and the speaker's voice is output through the speaker facing the receiving listener's ear, the receiving listener thus primarily hears the speaker's voice and the undesired surrounding listeners hear both signals 203 and 223 combined together. When comparing the voice signal regions with the formants in the spectrograms 253 and 293, it can be seen that the disturbance sounds also exist in the regions with intensive voice signals. That is, since the disturbance sounds are generated according to formant information, varying depending upon the presence of the voice, the content of an overheard conversation can be disturbed.

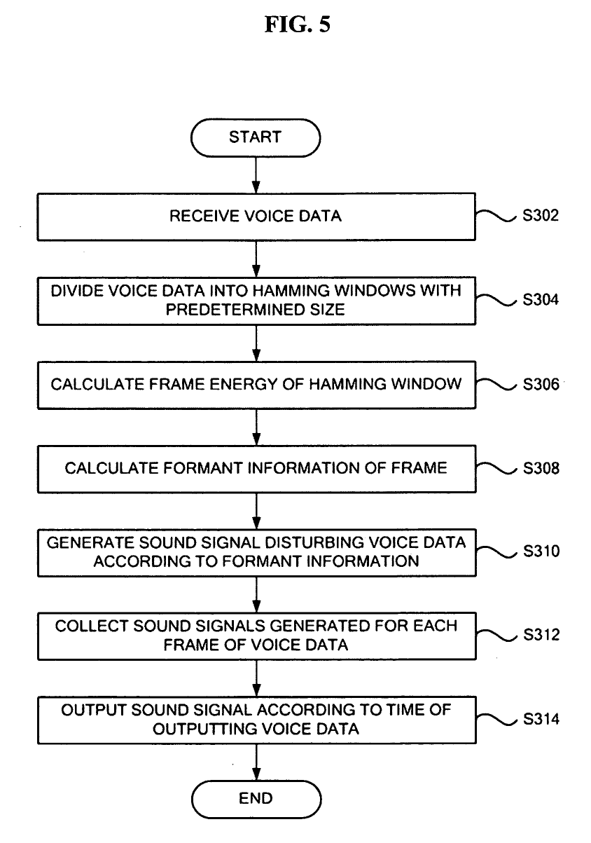

FIG. 5 illustrates a process of outputting a disturbance sound signal through obtaining the formant of voice data, according to an embodiment of the present invention.

Voice data may be received through telephones and mobile phones, for example, in operation S302. Received voice data may be divided into hamming windows with a predetermined size, in operation S304. The size of the frames may be selected and determined in general within 10˜30 ms, for example, noting that alternative embodiments are equally available. In addition to the frame size, the overlapping size of the respective frames can also be determined, according to an embodiment of the present invention. This overlapping prevents the disconnection of adjacent frames at a boundary between the frame. The energy of a frame may be calculated at the divided hamming window, in operation S306. Then, formant information of the frame may be calculated in operation S308. As described before, the formant information of the frame includes a frequency, a bandwidth, energy or gain of a signal, and others. Herein, as only an example, three to five formant information may be obtained, wherein a first formant may have a lowest frequency, and second and third formants have higher frequencies in series, for example.

When the formants have been obtained, an additional sound signal may be generated to disturb voice data based on the corresponding formant information, in operation S310. The additional sound signal can be extracted from natural sounds such as purl or birdcall according to the user's selection, for example. Alternatively, the additional sound signal can be obtained by pink-noise sine waves. Then, three to five sound signals may be obtained for each formant. The formants generated for the frame may then be collected into one sound signal, in operation S312. The collected sound signal may then be output at the same time or at predetermined intervals from the output of voice data, in operation S314. The predetermined interval may amount the overlapping size of the hamming windows.

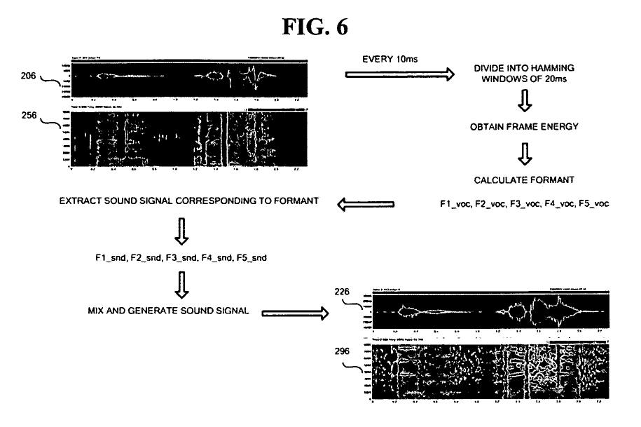

FIG. 6 illustrates a processing of a voice signal, according to an embodiment of the present invention. Here, a received voice signal 206 may be divided into hamming windows at predetermined time intervals (10 ms). In FIG. 6, the received voice signal 206 is divided into hamming windows with a size of 20 ms, for example. As a result, a spectrogram 256 may be obtained. Then, frame energy and formants may be calculated. Consequently, here, in this example, five formants F1_voc, F2_voc, F3_voc, F4_voc, and F5_voc are extracted. Sound signals corresponding to the respective formants may then be extracted. As a result, sound signals F1_snd, F2_snd, F3_snd, F4_snd, and F5_snd are obtained. When mixing the sound signals, a spectrogram 296 is obtained. Then, the sound signals 226 may be output together. In this example, the additional sound output through the spectrogram 226 has a magnitude covering the energy of the sound 206. Accordingly, the voice contents transmitted through the sound 206 can be disturbed or masked by the signal from the sound 226, thereby disturbing the voice contents.

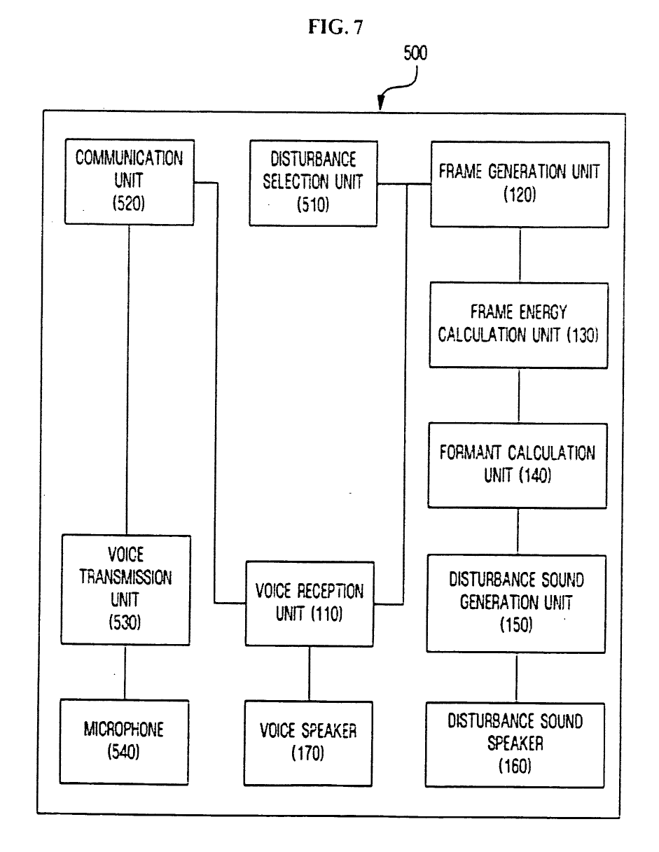

FIG. 7 illustrates a mobile phone, according to an embodiment of the present invention. The voice reception unit 110, the frame generation unit 120, the frame-energy calculation unit 130, the formant calculation unit 140, the disturbance sound generation unit 150, the disturbance sound speaker 160, and the voice speaker 170 were discussed above regarding the sound system of FIG. 1, a detailed description thereof will be omitted.

As illustrated in FIG. 5, a communication unit 520 may serve to enable the mobile phone 500 to communicate with a base station, with voice data being transmitted/received through the communication unit 520. The user's voice may be transmitted to the communication unit 520 through a microphone 540 and a voice transmission unit 530, for example. Voice data received through the communication unit 520 may also be input to the voice speaker 170, through the voice reception unit 110, enabling the user of the mobile phone to converse with others. Meanwhile, the voice reception unit 110 may also provide the voice signal to the frame generation unit 120 in order to generate the disturbance sound. When the disturbance sound has been generated, by the disturbance sound generation unit 150, through the above-mentioned processes, the disturbance sound may be output through the disturbance sound speaker 160. Herein, the user may select whether to disturb the voice signal depending on the contents of the conversation or counterpart of the conversation, through a disturbance selection unit 510, for example. When the user selects the disturbance of the conversation, the signal from the voice reception unit 110 may be transmitted to the frame generation unit 120, thereby generating the disturbance sound.

By the sounds output from the voice speaker 170 and the disturbance sound speaker 160, surrounding undesired listeners cannot understand the sound from the voice speaker 170. Meanwhile, the user of the mobile phone can have a conversation with others without being hindered by the disturbance sound speaker 160 since the disturbance sound speaker 160 faces outward, while the voice speaker 170 faces inward toward the user's.

The mobile phone illustrated in FIG. 7 can be adapted to a wired or wireless transceiver, such as a wired telephone or radio. For example, in the case of a walkie-talkie type radio, since the speaker's voice is heard loudly, an additional speaker may be installed on the back face thereof to generate the disturbance sound. In embodiments of the present invention, it is desirable to design the outward speaker so that the disturbance sound is output at a position separated as far as possible from the voice speaker to which the speaker's voice is output to the user. In addition, when the disturbance sound speaker is positioned in an opposite direction from the output direction of the voice speaker, the disturbance sound can be more easily diffused.

As described above, according to embodiments of the present invention, the audio of a conversation, e.g., in a mobile-phone call or a wired-telephone call, can be masked so as not to be understood by the others or ease dropping devices, thereby maintaining privacy.

In addition, a disturbance sound can be generated based upon formant information of the voice signal so that the surrounding listeners cannot understand the content of the conversation, and the user can have a conversation in the vicinity of another party without hindrance, and without having to move to other locations for more privacy.

Above, embodiments of the present invention have been described with reference to the accompanying drawings, e.g., illustrating block diagrams and flowcharts, for explaining a method, medium, and system for masking a user's voice through output of a disturbance signal similar to a formant of voice data, for example. It will be understood that each block of such flowchart illustrations, and combinations of blocks in the flowchart illustrations, may be implemented by computer readable instructions of a medium. These computer readable instructions may be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks.

These computer program instructions may be stored/transferred through a medium, e.g., a computer usable or computer-readable memory, which can instruct a computer or other programmable data processing apparatus to function in a particular manner. The instructions may further produce another article of manufacture that implements the function specified in the flowchart block or blocks.

In addition, each block of the flowchart illustrations may represent a module, segment, or portion of code, for example, which makes up one or more executable instructions for implementing the specified logical operation(s). It should also be noted that in some alternative implementations, the operations noted in the blocks may occur out of order. For example, two blocks shown in succession may in fact be executed substantially concurrently or the blocks may sometimes be executed in the reverse order, depending upon the functionality involved.

In embodiments of the present invention, the term “module”, “unit”, or “table,” as potentially used herein, may mean, but is not limited to, a software or hardware component, such as a Field Programmable Gate Array (FPGA) or Application Specific Integrated Circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables, noting that alternative embodiments are equally available. In addition, the functionality provided for by the components and modules may be combined into fewer components and modules or further separated into additional components and modules. Further, such a persistence compensation apparatus, medium, or method may also be implemented in the form of a single integrated circuit, noting again that alternative embodiments are equally available.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of masking voice information, comprising:
dividing voice information into a plurality of frames;
obtaining formant information from intensive signal regions within each of the plurality of frames;
generating a sound signal related to the formant information for each of the plurality of frames; and
outputting the sound signal based on a time when the voice information is to be output.

2. The method of claim 1, further comprising transforming each of the frames into a frequency domain and measuring magnitudes within each transformed frame.

3. The method of claim 1, further comprising receiving the voice information.

4. The method of claim 1, wherein the dividing of the voice information divides frames such that the divided frames are continuous and overlap by a predetermined amount.

5. The method of claim 1, wherein the dividing of the voice information divides frames as windows of a predetermined size, the windows being divided from the voice information to overlap by an amount smaller than the predetermined size of the windows.

6. The method of claim 1, wherein the frames result from dividing the voice information at predetermined time intervals.

7. The method of claim 1, wherein the obtaining of formant information for intensive signal regions involves obtaining formant information according to frequency, bandwidth, and/or energy information of each respective frame.

8. The method of claim 1, wherein the sound signal is a signal offsetting frame energy of at least one formant of each frame.

9. The method of claim 1, wherein the generating of the sound signal includes generating and combining sound signals generated for multiple frames.

10. The method of claim 1, wherein the sound signal is output through an output unit that does not output the voice information.

11. A system for masking voice information, comprising:
a frame generation unit to divide the voice information into a plurality of frames;
a formant calculation unit to calculate formant information from intensive signal regions within each of the plurality of frames;
a disturbance-signal generation unit to generate a sound signal related to the formant information for each of the plurality of frames; and
a disturbance-signal output to output the sound signal based on a time when the voice information is to be output.

12. The system of claim 11, wherein the frame generation unit further transforms each of the frames into a frequency domain and measures magnitudes within each transformed frame.

13. The system of claim 11, further comprising a receiving unit to receive the voice information.

14. The system of claim 11, wherein the dividing of the voice information divides frames such that the divided frames are continuous and overlap by a predetermined amount.

15. The system of claim 11, wherein the dividing of the voice information divides frames as windows of a predetermined size, the windows being divided from voice information to overlap by an amount smaller than the predetermined size.

16. The system of claim 11, wherein the frames result from dividing the voice information at predetermined time intervals.

17. The system of claim 11, wherein the formant calculation unit obtains the formant information according to frequency, bandwidth, and/or energy information of each respective frame.

18. The system of claim 11, wherein the sound signal is a signal offsetting frame energy of at least one formant of each frame.

19. The system of claim 11, wherein the disturbance-signal generation unit generates and combines sound signals generated for multiple frames.

20. The system of claim 11, further comprising a disturbance selection unit to selectively control masking of the voice information.

21. The system of claim 11, further comprising a communication device to transmit and receive audio information.

22. The system of claim 11, further comprising a first speaker to output the voice information and a separate second speaker to output the sound signal.

23. The system of claim 23, wherein the frame generation unit, the formant calculation unit, the disturbance-signal generation unit, the disturbance-signal output, and the first and second speakers are embodied in a single apparatus body.

24. At least one medium comprising computer readable code to implement the method of claim 1.
